(19) United States
(12) Patent Application Publication
(10) Pub. No.: US 2015/0317730 A1
(43) Pub. Date: Nov. 5, 2015

(54) Customizable Digital Trade Order Ticket

(71) Applicant: FMR LLC, Boston, MA (US)

(72) Inventors: Boris Kalinichenko, Jamaica Plain, MA (US); Jorge E. Nario, Brookline, MA (US)

(73) Assignee: FMR LLC, Boston, MA (US)

(21) Appl. No.: 14/266,270

(22) Filed: Apr. 30, 2014

(51) Int. Cl. G06Q 40/04; G06Q 20/04

(52) U.S. Cl. CPC G06Q 40/04; G06Q 20/0457

(57) ABSTRACT

Methods and systems for configuring a digital trade order ticket to facilitate a computer trade are provided. A request to create a digital trade order ticket is received by a computing device. A template is selected from a plurality of templates in the event that an authentication indicator indicates the request is authenticated. Each template includes a consumer identifier, trade order characteristics that are unique to a user assigned to the consumer identifier, trade order characteristics that are generic to all users, and instructions that are unique to the user. The template that is selected has a consumer identifier that matches the consumer identifier in the request. The digital trade order ticket is displayed to the user based on the template.

### FIELD OF THE INVENTION

The invention relates generally to computer-based methods for configuring a digital trade order ticket. More specifically, the invention relates to generating digital trade order tickets based on generic and consumer specific information.

### BACKGROUND

Current methods and systems for trading include placing a trade on a computer. Placing trades on a computer typically requires presenting a trade order ticket to a user to input certain data items related to a desired trade order into the trade order ticket. Computerized methods for trading typically include presenting a digital trade order ticket to a user on a display. Direct market access typically occurs through a single channel and is typically exposed to a consuming application in a uniform manner. However, different organizations typically have different requirements for trade orders, such that each organization develops its own digital trade order ticket and corresponding transformation into the single channel format required for each particular market.

Current digitized trade order tickets typically have a format, data, and/or functionality that is specific to requirements of each particular digitized trade order ticket provider, regulatory requirements, competitive needs, and/or type of user. The format, data and/or functionality is created, stored, and maintained by each digitized trade order ticket provider and thus requires each trade order ticket provider to create, maintain, and/or update their own digitized trade order ticket.

Although the format, data, and/or functionality of each digitized trade order can be different, once the data is input into the trade order ticket, the ticket data is formatted to be accepted by a particular electronic market place for execution (e.g., New York Stock Exchange (NYSE). For example, organization A can present a digitized trade ticket order for a trade order to be executed on the NYSE] market and require that a user input an expiration time for a limit stock order. Organization B can present a digitized trade order ticket for a trade, order to be executed on the same NYSE exchange and not require that the user input hat a user input an expiration time for a limit stock order. Thus, both organization A and organization B present digitized trade order tickets to be executed on the same market, and each individually prepares the input data and executes the functionality necessary to interface with the NYSE.

Therefore, it is desirable to configure trade order tickets for use across multiple organizations.

### SUMMARY OF THE INVENTION

One advantage of the claimed invention includes enabling multiple organizations to retain their specific trade order ticket requirements while allowing for certain aspects of the trade order ticket to be reused between organizations. Another advantage of the claimed invention is reduction of cost by eliminating the need for each organization to store and maintain all of the information necessary to execute a digital trade order ticket. Another advantage of the claimed invention is reduction of errors due to an increase in uniformity of digitized trade order tickets across multiple organizations.

In one aspect, the invention features a computerized-method for configuring a digital trade order ticket to facilitate a computer trade. The method involves receiving, by a computing device, a request to create a digital trade order ticket, the request comprising a consumer identifier and an authentication indicator, the authentication indicator indicates whether the request is authenticated. The method also involves selecting, by the computing device, one template from a plurality of templates in the event that the authentication indicator indicates the request is authenticated. Each template includes a consumer identifier, trade order ticket characteristics that are unique to a user assigned the consumer identifier, trade, order ticket characteristics that are generic to all users, and instructions that are unique to the user assigned to the consumer identifier. The selected template has a consumer identifier that matches the consumer identifier in the request. The method also involves transmitting, by the computing device, the selected template to the requestor over a communication network.

In some embodiments, the trade order ticket characteristics that are unique to the user comprise data elements and display instructions that indicate dress of the data elements to be presented to the user. In some embodiments, the data elements include input fields, labels, buttons or any combination thereof. In some embodiments, the dress of the data elements includes color, font, margins or any combination thereof.

In some embodiments, the instructions indicate actions to be taken in response to input given by the user upon display of the trade order ticket to the user. In some embodiments, each template further comprises instructions that indicate to a browser positioning of each of the trade order characteristics that are unique to the user and each of the trade order characteristics that are generic to all users.

In some embodiments, the method also features transmitting, by the computing device, a failure indicator in the event that the authentication indicator indicates that the request is not authenticated, the transmitting is over a communications network.

In another aspect, the invention features a computerized-implemented system for configuring a digital trade order ticket to facilitate computer triggered trades. The system includes a server configured to receive a request to create a digital trade order ticket, the request comprising a consumer identifier and an authentication indicator, the authentication indicator indicates whether the request is authenticated. The server is also configured to select one template from a plurality of templates in the event that the authentication indicator indicates the request is authenticated. Each template includes a consumer identifier, trade order ticket characteristics that are unique to a user assigned the consumer identifier, trade order ticket characteristics that are generic to all users, and instructions that are unique to the user assigned to the consumer identifier. The selected template has a consumer identifier that matches the consumer identifier in the request. The server is also configured to transmit the selected template to the requestor over a communication network.

In another aspect, the invention features a computer program product, tangibly embodied in a computer readable storage medium, for dynamically generating a mobile application. The computer program product including instructions operable to cause a data processing apparatus to receive, by a computing device, a request to create a digital trade order ticket, the request comprising a consumer identifier and an authentication indicator, the authentication indicator indicates whether the request is authenticated. The instructions are also operable to cause a data processing apparatus to select, by the computing device, one template from a plurality of templates in the event that the authentication indicator indicates the request is authenticated. Each template includes a consumer identifier, trade order ticket characteristics that are unique to a user assigned the consumer identifier, trade order ticket characteristics that are generic to all users, and instructions that are unique to the user assigned to the consumer identifier. The selected template is the template that has a consumer identifier that matches the consumer identifier in the request. The instructions are also operable to cause a data processing apparatus to select transmit, by the computing device, the selected template to the requestor over a communication network.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing an exemplary computing system for configuring a digital trade order ticket, according to an illustrative embodiment of the invention.

FIG. 2 is a block diagram showing an exemplary model for configuring a digital trade order ticket, according to an illustrative embodiment of the invention.

FIG. 3 is a flow diagram showing a method for configuring a digital trade order ticket, according to an illustrative implementation of the invention.

FIG. 4 is a screen shot showing an exemplary trade order ticket interface, according to an illustrative embodiment of the invention.

FIG. 5 is a screen shot showing an exemplary trade order ticket interface, according to an illustrative embodiment of the invention.

### DETAILED DESCRIPTION

Generally, a user makes a request to place an electronic trade using an application on a computer (e.g., at a browser). The computer application authenticates the user according to authentication procedures of the application. Once authentication is successful, the user's request for a trade order ticket along with a consumer identifier and authentication information is sent to a second application. The second application verifies that the user has been authenticated, and uses the consumer identifier to select a trade order ticket template having a matching consumer identifier to return to the user. The trade order ticket template includes data items, instructions, and/or formatting data that are unique to the consuming application. The second application then transmits the trade order ticket template including trade order ticket data and functionality (e.g., instructions) that is common (or generic) to a market of the trade order ticket to the consuming application. The consuming application presents the trade order ticket with the organization specific and common trade order ticket data and functionality according to the template to the user.

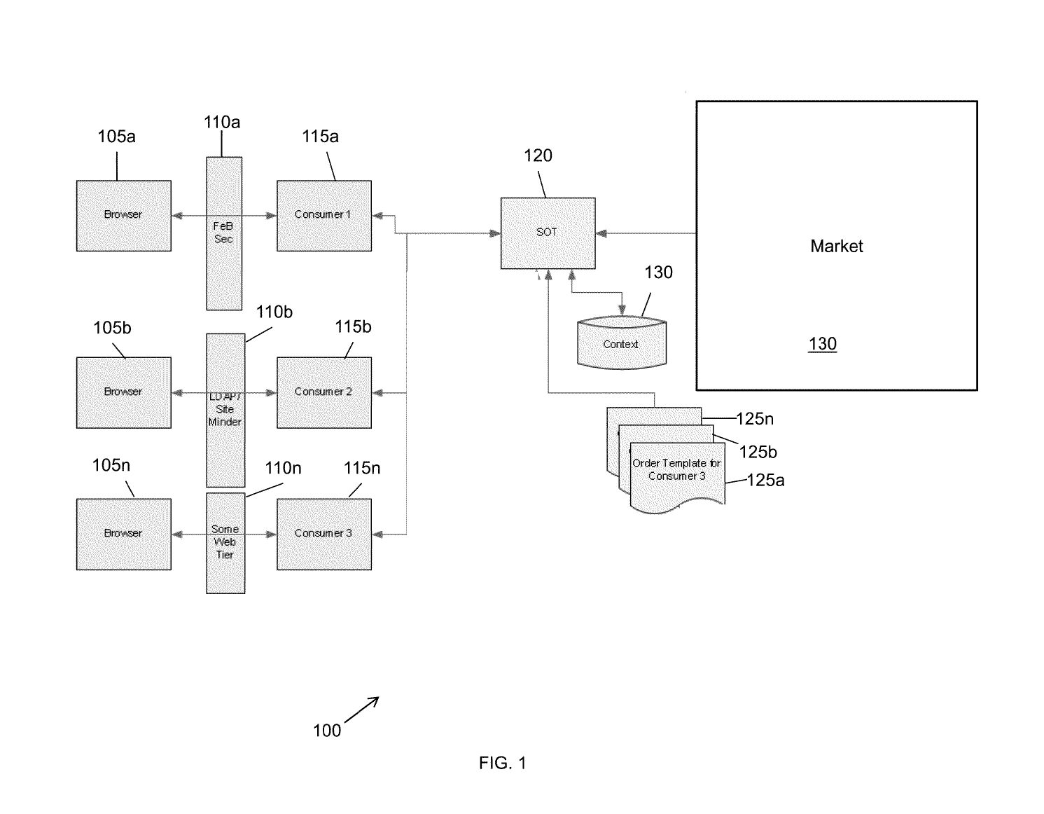

FIG. 1 is a block diagram showing an exemplary computing system 100 for configuring a digital trade order ticket, according to an illustrative embodiment of the technology. The computing system includes one or more browsers, 105a, 105b, . . . 105n, generally 105, one or more security gateways, 110a, 110b, . . . 110n, generally 110, one or more consuming applications, 115a, 115b, . . . 115n, generally 115, a trade order ticket module 120, a context module 130, and an exemplary market 135.

The browsers 105 are in communication with the consuming applications 115 via security gateways 110. The consuming applications 115 are in communication with the trade order ticket module 120. The trade order ticket module 120 is in communication with the context module 130 and the market 135. The communication between the components of computing system 100 can be wired or wireless. It is understood by one of ordinary skill in the art that in some embodiments, the components of computing system 100 are implemented by one computing device, and in various other embodiments, the components of computing system 100 are implemented in any number of computing devices.

The trade order ticket module 120 includes one or more templates 125a, 125b, . . . 125n (generally 125). Each template 125 includes data, functionality and/or display dress for a trade order ticket that is unique to a consuming application. For example, consuming application 115a can require that all account numbers be displayed in bold on the upper right portion of a graphical user interface, while consuming application 115b can require that all account numbers be displayed in white on the lower left portion of a graphical user interface.

In some embodiments, the dress of the graphical user interface includes color, size, font, and/or placement. The dress of the graphical user interface can be any graphical user interface display characteristic as is known in the art.

In some embodiments, functionality of the graphical user interface includes pull down menu, push buttons, pop-up windows, and/or enter text boxes. The functionality of the graphical user interface can be any functionality currently used in the art with a graphical user interface.

In some embodiments, the data is trade related data. For example, latest real-time bid and ask prices with the corresponding bid and ask sizes can be presented to the trader.

The context module 130 includes data, functionality and/or display dress that is common to all consuming applications for each market. For example, a ticker symbol input field should be presented for all the consuming applications.

During operation, a user inputs a request for a digital trade order into the browser 105. The consuming application 115 authenticates the user. Once authenticated, the request, which includes a consumer identifier, is transmitted to the trade order ticket module 120. The trade order ticket module 120 retrieves a template from the one or more templates 125 that has a consumer identifier that is equal to the consumer identifier transmitted with the request. The trade order ticket module 120 retrieves context data from the context module 130 based on the market the trade order ticket is to be executed on. The trade order ticket module 120 transmits the selected template along with the context data to the consuming application 115. The consuming application 115 transmits the template having the context data to the browser 105 for display.

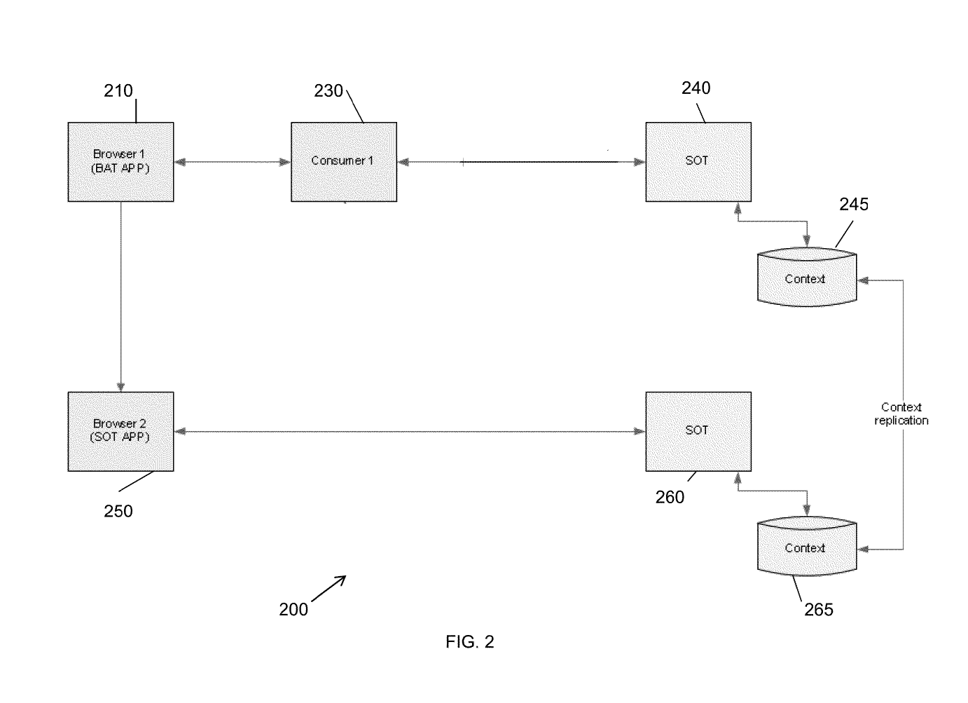

FIG. 2 is a block diagram showing an exemplary method of configuring a digital trade order ticket through a computing system 200, according to an illustrative embodiment of the technology.

The computing system 200 includes a first browser 210. The first browser 210 receives input from a user indicating a desire to place a digital trade. The first browser 210 transmits the request to initiate a digital trade to a consuming application 230. The consuming application 230 authenticates the user. If the user is authenticated, the consuming application 230 transmits the request to initiate a digital trade to a trade order ticket module 240. The trade order ticket module 240 communicates with a first context module 245. The first context module 245 selects a trade order ticket template that corresponds to user identification information to transmit to the trade order ticket module 240.

The trade order ticket module 240 transmits the trade order ticket template that includes trade order ticket information that is common (e.g., generic) to all users to the consuming application 230. In some embodiments, the trade order ticket module 240 transmits a token to the consuming application 230. The consuming application 230 transmits the trade order ticket template including the generic trade order ticket information to the first browser 210. The first browser 210 opens a second browser 250 in the first browser 210 and displays the trade order ticket based on the trade, order ticket template and the generic trade order ticket information.

In some embodiments, the trade order ticket module 240 is replicated at one or more geographical locations. For example, the trade order ticket module 240 can be located in Dallas and a second trade order ticket module 260 can be located in New York City. The second trade order ticket module 260 can include its own context module 265. The context module 265 can be in communication with the first context module 245, such that when updates are made to either context module 245, 265, the updates are replicated on both context modules 245, 265.

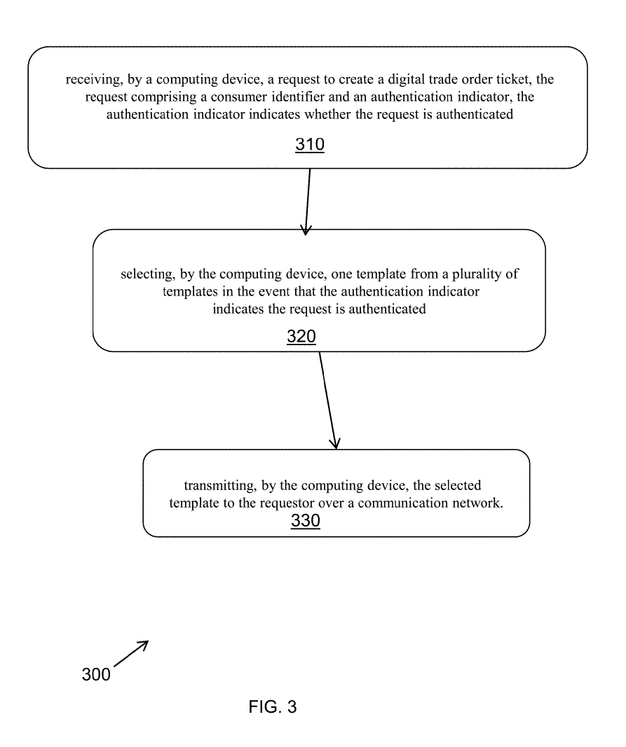

FIG. 3 is a flow diagram 300 showing a method for configuring a digital trade order ticket, according to an illustrative implementation of the technology.

The method involves receiving by a computing device (e.g., computing system 100 as shown above FIG. 1), a request to create a digital trade, order ticket (Step 310). The request can include a consumer identifier and an authentication indicator. The request can also include restrictions indicators that limit the digital trade order ticket to accept trade requests for a particular security type (e.g., equity, options, mutual funds, and/or fixed income). The consumer identifier can be input by a user or assigned by the consuming application. The authentication indicator indicates whether the request is authenticated.

The method also involves selecting, by the computing device, one template from a plurality of templates in the event that the authentication indicator indicates the request is authenticated (Step 320). The selected template has a consumer identifier that matches the consumer identifier in the request. As described above in FIG. 1, a plurality of templates can be stored. Each of the plurality of templates can be associated with a consuming application, a particular user, and/or a group of users. Each of the plurality of templates can include instructions to be executed by the consuming application. For example, some consuming applications may require that a user input having keyboard up and down arrows be displayed to the user. In this example, the template can include instructions for including a user input field having keyboard up and down arrows that are interpretable by a browser. In another example, another consuming application can require that a user have direct access to a mutual fund prospectus by, for example, presenting a link that will take a user directly into a fund prospectus for a mutual fund that a user is attempting to buy. In yet another example, the third application can require providing access to a. “depth of book” information for a security that a user is trying to trade by, for example, presenting such information in the trade ticket.

In some embodiments, the template includes a consumer identifier, trade order ticket characteristics that are unique to a user assigned the consumer identifier, trade order ticket characteristics that are generic to all users, and instructions that are unique to the user assigned to the consumer identifier.

The method also involves transmitting, by the computing device, the selected template to the requestor over a communication network (Step 330). The selected template can be interpreted by a browser for display.

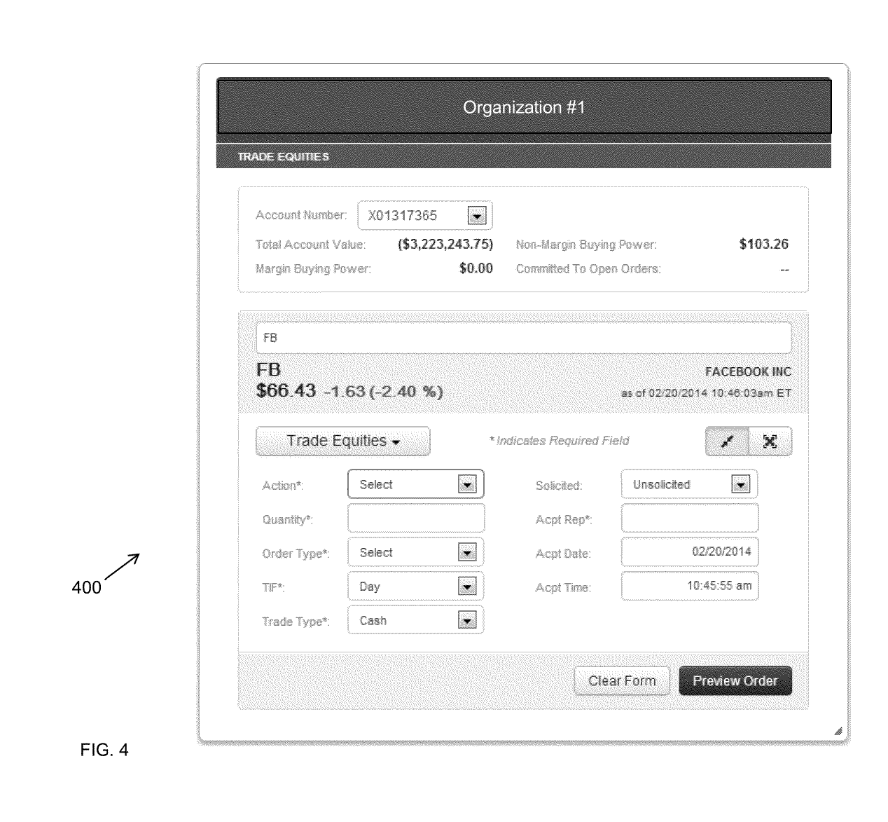

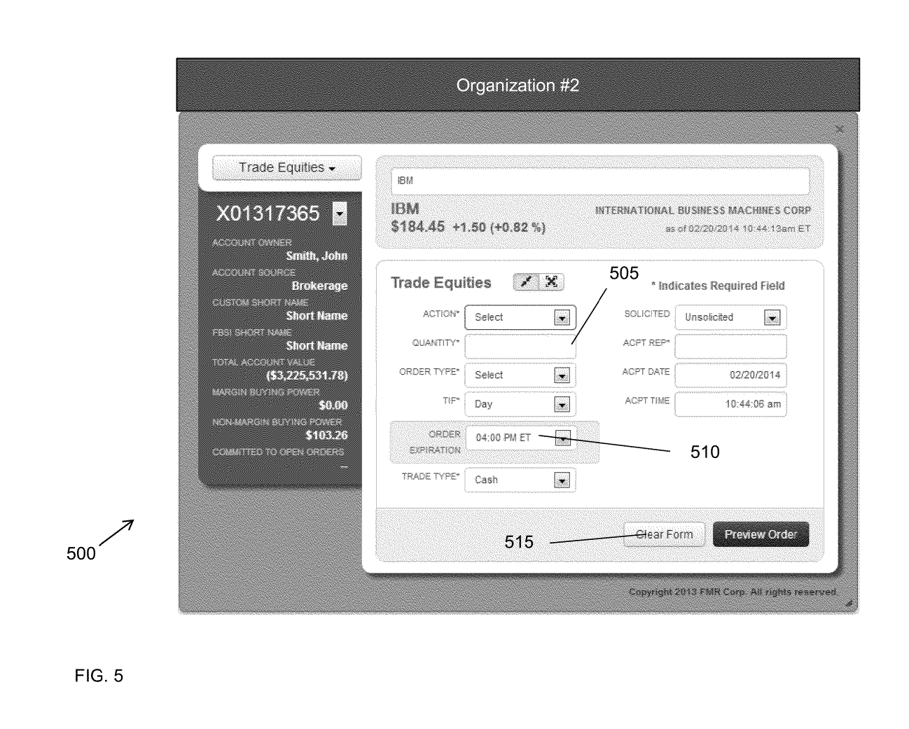

FIG. 4 and FIG. 5 are screen shots showing exemplary trade order ticket graphical user interfaces 400 and 500, respectfully, according to illustrative embodiments of the invention. In both FIG. 4 and FIG. 5, the trade order ticket graphical user interfaces 400, 500 display interfaces for a trade order ticket type of trading equities. The trade order ticket graphical user interfaces 400, 500 have one or more input fields that are the same (e.g., generic fields that are presented to all users trading equities). For example, both interfaces 400, 500 present an input field of quantity 405, 505, respectively. The trade order ticket graphical user interfaces 400, 500 have one or more of the input fields that are unique to a particular consumer. For example, graphical user interface 500 presents an input field of order expiration time 510 and graphical user interface, 400 does not.

On the trade order ticket graphical user interfaces 400, 500, one or more functions are the same. For example, on both ticket graphical user interfaces 400, 500, clicking on a clear form button 415, 515, respectively, results in instructions that clear the entries from the form to be executed. In some embodiments, on the trade order ticket graphical user interfaces 400, 500 one or more functions can be different. For example, order Expiration 510 can only be manually manipulated in graphical user interface 500 and only graphical user interface 500 ensures that the expiration time is in the future.

The above-described systems and methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a world wide web browser Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional pacts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A computerized-method of configuring a digital trade order ticket to facilitate a computer trade, the method comprising:
receiving, by a computing device, a request to create a digital trade order ticket, the request comprising a consumer identifier and an authentication indicator, the authentication indicator indicates whether the request is authenticated;
selecting, by the computing device, one template from a plurality of templates in the event that the authentication indicator indicates the request is authenticated, each template comprises:
a consumer identifier,
trade order ticket characteristics that are unique to a user assigned the consumer identifier,
trade order ticket characteristics that are generic to all users, and
instructions that are unique to the user assigned to the consumer identifier,
wherein the selected template has a consumer identifier that matches the consumer identifier in the request; and
transmitting, by the computing device, the selected template to the requestor over a communication network such that a computing device can create the digital trade order ticket by applying the selected template to a generic digital trade order ticket.

2. The computerized-method of claim 1 wherein the trade order ticket characteristics that are unique to the user comprise data elements and display instructions that indicate dress of the data elements to be presented to the user.

3. The computerized-method of claim 2 wherein the data elements include input fields, labels, buttons or any combination thereof.

4. The computerized-method of claim 2 the dress of the data elements includes color, font, margins or any combination thereof.

5. The computerized-method of claim 1 wherein the instructions indicate actions to be taken in response to input given by the user upon display of the trade order ticket to the user.

6. The computerized-method of claim 1 wherein each template further comprises:
instructions that indicate to a browser positioning of each of the trade order characteristics that are unique to the user and each of the trade order characteristics that are generic to all users.

7. The computerized-method of claim 1 further comprising transmitting, by the computing device, a failure indicator in the event that the authentication indicator indicates that the request is not authenticated, the transmitting is over a communications network.

8. A computerized-implemented system for configuring a digital trade order ticket to facilitate computer triggered trades, the method comprising:
a server configured to:
receive a request to create a digital trade order ticket, the request comprising a consumer identifier and an authentication indicator, the authentication indicator indicates whether the request is authenticated;
select one template from a plurality of templates in the event that the authentication indicator indicates the request is authenticated, each template comprises:
a consumer identifier,
trade order ticket characteristics that are unique to a user assigned the consumer identifier,
trade order ticket characteristics that are generic to all users, and
instructions that are unique to the user assigned to the consumer identifier,
the selected template has a consumer identifier that matches the consumer identifier in the request; and
transmit the selected template to the requestor over a communication network such that a computing device can create the digital trade order ticket by applying the selected template to a generic digital trade order ticket.

9. A computer program product, tangibly embodied in a computer readable storage medium, for dynamically generating a mobile application, the computer program product including instructions operable to cause a data processing apparatus to:
receive, by a computing device, a request to create a digital trade order ticket, the request comprising a consumer identifier and an authentication indicator, the authentication indicator indicates whether the request is authenticated;
select, by the computing device, one template from a plurality of templates in the event that the authentication indicator indicates the request is authenticated, each template comprises:
a consumer identifier,
trade order ticket characteristics that are unique to a user assigned the consumer identifier,
trade order ticket characteristics that are generic to all users, and
instructions that are unique to the user assigned to the consumer identifier,
the selected template is the template that has a consumer identifier that matches the consumer identifier in the request; and
transmit, by the computing device, the selected template to the requestor over a communication network such that a computing device can create the digital trade order ticket by applying the selected template to a generic digital trade order ticket.
